(19) United States
(12) Patent Application Publication
(10) Pub. No.: US 2014/0059631 A1
(43) Pub. Date: Feb. 27, 2014

(54) User Communication Management Center

(71) Applicant: Vladimir SMELYANSKY, Glenview, IL (US)

(72) Inventor: Vladimir SMELYANSKY, Glenview, IL (US)

(21) Appl. No.: 13/973,762

(22) Filed: Aug. 22, 2013

Related U.S. Application Data
(60) Provisional application No. 61/691,998, filed on Aug. 22, 2012.

(51) Int. Cl. H04N 21/61

(52) U.S. Cl. CPC H04N 21/61
USPC 725/109

(57) ABSTRACT

The present invention provides integration of separate functions, such as television viewing, Internet television viewing, gaming, video recording, telephone call handling, etc. in a user friendly way. For example, a system for providing unified services may comprise a server system utilizing a universal open protocol that provides the capability for different service providers to offer services over unified cable/TV/Internet network independent technologically from particular network providers, and a plurality of client systems, each client system utilizing the protocol to provide integrated services to a user.

### CROSS-REFERENCE TO RELATED APPLICATIONS

This application claims the benefit of Provisional Application No. 61/691,998, filed Aug. 22, 2012, the contents of which are incorporated herein in their entirety.

### BACKGROUND OF THE INVENTION

1. Field of the Invention

The present invention relates to providing integration of separate functions, such as television viewing, Internet television viewing, gaming, video recording, telephone call handling, etc. in a user friendly way.

2. Description of the Related Art

There are a number of existing devices and applications include separate functions. For example, there are Internet appliances that allow watching TV over the Internet on regular TV. There are game consoles that allow the playing of games and perhaps the viewing of DVDs. There are telephone answering systems that allow calls to be answered, messages taken, etc. There are mobile phones, tablets, etc., that provide some mix of telephone and data functions. However, each of these devices is separate from the others. These devices do not communicate with each other and do not interoperate with each other. Using two or more independent services and independent technologies is cumbersome and doesn't work in all cases. Likewise, to control all of these independent devices, one must use a wireless keyboard and mouse plus multiple remote controls or a special unified remote control.

A need arises for a system that will provide integration of these separate functions in a user friendly way.

### SUMMARY OF THE INVENTION

The present invention provides integration of separate functions, such as television viewing, Internet television viewing, gaming, video recording, telephone call handling, etc. in a user friendly way.

For example, a system for providing unified services may comprise a server system utilizing a universal open protocol that provides the capability for different service providers to offer services over unified cable/TV/Internet network independent technologically from particular network providers, and a plurality of client systems, each client system utilizing the protocol to provide integrated services to a user.

The client system may be connectable to, and compatible with, existing televisions and monitors. The client system may be included in a television. The protocol may have a session negotiation and identification part and a session description part. The session negotiation and identification part may be Session Initiation Protocol and the session description part may be Session Description Protocol. The protocol may be open and allow custom or public extensions. The protocol may include Session Initiation Protocol for Instant Messaging and Presence Leveraging Extensions. The client system may provide a firewall that does not need configuration by the user. The server system may provide authorization and collection of payment from users by an operator of the server system, an independent provider, or both.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a network environment, in which the present invention may be implemented.

FIG. 2 is an exemplary diagram of components of network environment.

FIG. 3 is an exemplary block diagram of client kernel and application software at subscriber residences.

FIG. 4 illustrates an example of client hardware configured to provide User Management Center functionality.

FIG. 5 is an exemplary block diagram of additional possible configurations.

FIG. 6 illustrates an example of functionality of a Management Center device.

FIG. 7 is an exemplary block diagram of a Management Center device.

### DETAILED DESCRIPTION OF THE INVENTION

The present invention provides integration of separate functions, such as television viewing, Internet television viewing, gaming, video recording, telephone call handling, etc. in a user friendly way.

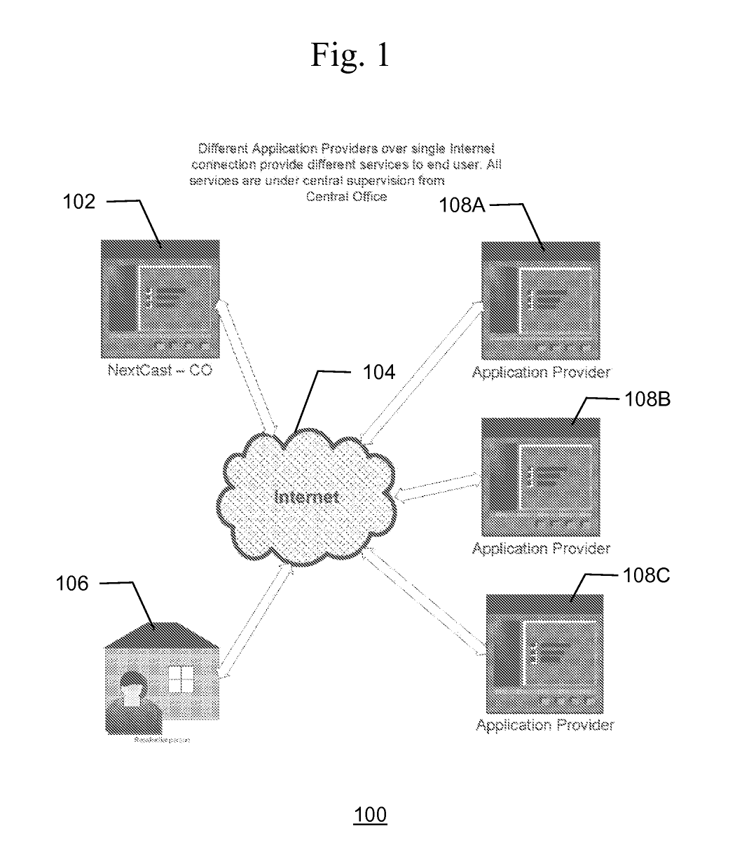

An exemplary diagram of a network environment 100, in which the present invention may be implemented, is shown in FIG. 1. Network environment 100 includes Central Office 102, a network 104, such as the Internet, one or more subscriber residences 106, and one or more application providers 108A-C. Central Office 102, subscriber residences 106, and application providers 108A-C each include hardware and software that is described in more detail below. There are four major parts of the software: server software at central office 102, proprietary and/or third party software included in application providers 108A-C, and client kernel and application software at subscriber residences 106. The server software may be proprietary and based on existing technology, or it may be otherwise provided. Application software may be proprietary or provided by third parties.

Examples of components that may be included in the server software architecture may include:

1. Load Balancer

2. Session Border Controller

3. Firewall

4. Authorization Module

5. Presence Module

6. Media Server

7. Remote API (XML, Jason, SOAP for third parties to integrate)

8. Application Module

9. Billing Module

10. Reporting Module

11. Monitoring Module

12. Provisioning Module

13. Application Store

14. Media Store

15. Web (or some other type of GUI, like flash) interfaces to all modules

16. Databases (most of the modules will have associated database, some of them may share the same, or have a few)

Application software is application dependent and could be anything—billing system, movies repository, banking, etc.

Third Party server software will be third party application dependent and could be anything—billing system, movies repository, banking, etc. Client software may be based on a provided proprietary Software Development Kit (SDK). This would allow third party developers to add applications as desired. The SDK may include Session Initiation Protocol (SIP)/Session Description Protocol (SDP) modules needed for end user authorization, firewall penetration, media handling, presence, VideoSoft Phone, TT Reporting, etc. There may also be generic applications such as chat, media player, etc. Also provided may be a set of media codecs including audio codecs, such as G.729, G.711, iLBC, etc., and video codecs, such as H.263, H.264, etc.

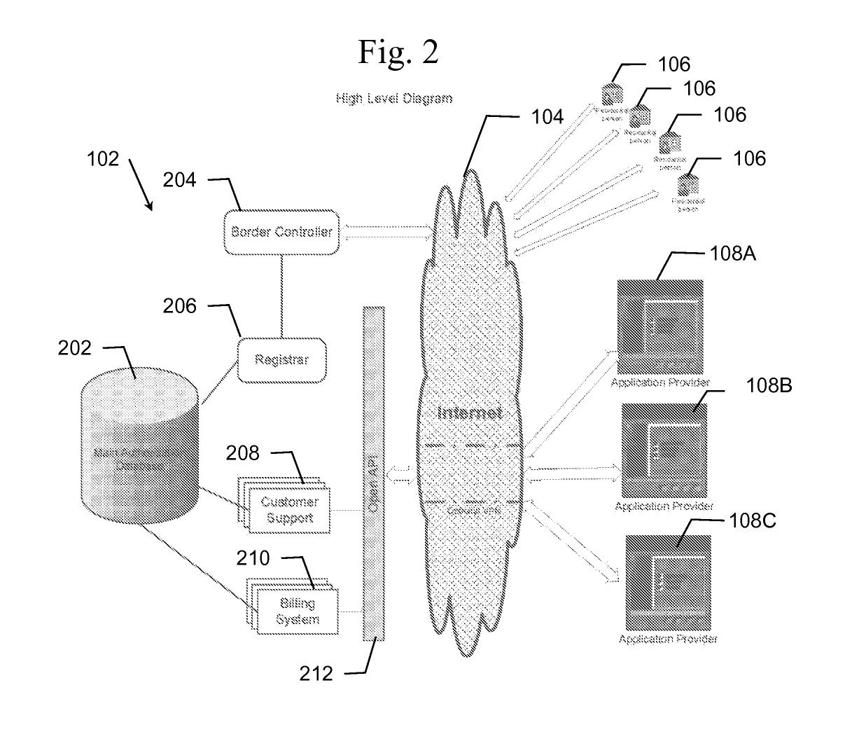

An exemplary diagram of components of network environment 100 is shown in FIG. 2. Central Office 102 includes Server Software components such as Main Authorization Database 202, Border Controller 204, Registrar 206, Customer Support 208, Billing System 210, and Open API 212.

Registration and authorization 206 may include Client Validation. Client software will have to register in real time with the server and provide proper credentials. Client Validation could be based on SIP authentication. The SIP authentication mechanism is described in RFC 3261 and provides a stateless challenge-based mechanism for authentication that is based on authentication in HTTP. Any time that a proxy server or UA receives a request (with the exceptions given in Section 22.1), it MAY challenge the initiator of the request to provide assurance of its identity. Once the originator has been identified. The recipient of the request SHOULD ascertain whether or not this user is authorized to make the request in question.

The “Digest” authentication mechanism provides message authentication and replay protection only, without message integrity or confidentiality. Protective measures above and beyond those provided by Digest need to be taken to prevent active attackers from modifying SIP requests and responses.

Due to its weak security, the usage of “Basic” authentication has been deprecated. Servers MUST NOT accept credentials using the “Basic” authorization scheme, and servers also MUST NOT challenge with “Basic”. This is a change from RFC 2543.

RFC2617 provides that SIP authentication is meaningful for a specific realm, a protection domain. Thus, for Digest authentication, each such protection domain has its own set of usernames and passwords.

A Realm is a string that is displayed to users so they know which username and password to use. This string should contain at least the name of the host performing the authentication and might additionally indicate the collection of users who might have access. An example might be “registered users@gotham.news.com”.

There are two responses that may be sent upon a failure to authenticate—a 401 or a 407. If the origin server does not wish to accept the credentials sent with a request it SHOULD return a 401 (Unauthorized) response. The response MUST include a WWW-Authenticate header field containing at least one (possibly new) challenge applicable to the requested resource. If a proxy does not accept the credentials sent with a request, it SHOULD return a 407 (Proxy Authentication required). The response MUST include a Proxy-Authenticate header field containing a (possibly new) challenge applicable to the proxy for the requested resource.

Under an authentication scheme that uses responses to carry values used to compute nonces (such as Digest), some problems come up for any requests that take no response, including ACK. For this reason, any credentials in the INVITE that were accepted by a server MUST be accepted by that server for the ACK. UACs creating an ACK message will duplicate all of the Authorization and Proxy-Authorization header field values that appeared in the INVITE to which the ACK corresponds. Servers MUST NOT attempt to challenge an ACK. Although the CANCEL method does take a response Ca 2xx), servers MUST NOT attempt to challenge CANCEL requests since these requests cannot be resubmitted. Generally, a CANCEL request SHOULD be accepted by a server if it comes from the same hop that sent the request being canceled (provided that some sort of transport or network layer security association).

In summary, SIP Authentication is done with an authentication username and authentication realm. The server challenges the user with a realm and a “nonce”. If the user has a username within this realm, it calculates a response based on a number of data, including a “secret”.

The authentication username doesn't have to be the same as the SIP user name. The authentication realm doesn't have to be the same as the SIP domain.

Another form of authentication is HTTP digest authentication. The HTTP digest authentication scheme is documented in RFC2617 and extended in RFC 3310. The HTTP digest authentication scheme involves a list of services that a user is ineligible for. For example a user might view movies from one service vendor, but cannot view movies from another service vendor. The scheme could be SIP based.

In the HTTP digest authentication scheme, each user is associated with a list of free and paid services in an authorization module that the particular user is eligible for. The actual service vendor identifies criteria to determine if a user is eligible or not. For example, some free services may be available to any user, including guests, while some free services may be available to all users that are registered with central system, and some free services may be available only to the users that have registered with particular service vendors.

Regarding pay services, some of them may be prepaid and some may be postpaid. Some of pay services may require direct registration with the service vendor, which processes the charges, while pay services may be charged by the Central Office operator, with the service vendor receiving part of the revenue. In some cases onetime payment directly to the service vendor or Central Office operator may be used, while in some cases subscription or any other type of billing plan may be used.

The information about service availability is stored in a central database that provides the ability for vendors to view, edit, or change it on a global, per user, or per product basis. The information may also be changed for different temporary promotions over the remote API.

In addition, information about user preferences may be utilized. For example, a user may prefer to only see action movies list from a service vendor by default. User preferences may be stored in tables, including what is available to the user and what products matches that identification. For example, for a user who can see only action movies, all action movies are marked as action. There also may be other properties, for example, that a user cannot watch only movies marked PG13 and “below”. This information may be stored in the central store databases, or with the actual service vendor. In the former case, service vendor will need to have user authorization on their side as well.

Accounting and billing functions are provided by Billing System 210. For example, end user billing may be provided or third party billing providers may provide end user billing. Thus, billing can be provided by network provider or by service vendors. When service vendors provide billing services, they determine how the billing is charged.

When the Central Office operator provides billing, the billing depends on the product/service. For example, for phone services, traditional phone billing is provided and the service vendor receives commissions from the invoice. For sales of physical objects, such as DVDs, the actual vendor specifies the price, and the Central Office operator receives a percentage of the sale price and handles the payment transactions. The actual payment may go over PayPal, credit card, or another on-line payment vendor/method. After the transaction is confirmed, the information about the transaction goes to the vendor for confirmation, after which the proper portions of the money are sent to the vendor financial account.

As another example, third party reseller billing may be provided. When the Central Office operator provides billing, commissions may be provided to third parties. For example, third party that develops a game may receive the commissions based on revenue that that game generates. For example, the game may be available to end users by monthly subscription. The Central Office operator server provides automatic charges from all users associated with a particular game (credit card, PayPal account). After a charge is confirmed, the proper percentage is moved to the actual product vendor financial account. That account could be a bank, or could be account with the Central Office operator. In this case, payment to the actual vendor may occur on weekly or monthly basis. It could be a similar financial transaction or actual check.

Border control and Firewall penetration protection functions are performed by Border Controller 204. For example, Border Controller 204 provides secure accessibility to end user devices behind a firewall. An example of a suitable border control function is described in U.S. Pat. No. 7,996,543 and in U.S. Patent Application Publication No. 2010/0218246, which are incorporated by reference herein. As an alternative, protection functions may utilize other solutions, such as a combination of Interactive Connectivity Establishment (ICE), Session Traversal Utilities for NAT (STUN), and Traversal Using Relays around NAT (TURN) technologies.

Border Controller 204 provides protection from different security attacks including SIP specific attacks. In addition, some of the security protection features are performed by the client device software. The server specific part is related to potential DOS and DDOS attacks. For example, the server part looks at the number of messages from a particular IP address (DOS) or the total number of messages from all end users. If the number of messages from particular IP exceeds a threshold limit, for example, 100 per second, that IP is temporarily blocked. The server also looks at the total number of messages from all IP addresses. If the velocity there exceeds some threshold, for example 2 million per second, it blocks all messages that come from IP addresses that are not associated with registered users.

The Central Office 102 also provides location and presence functions such as providing information on user current Internet status and location. This may, for example, be based on an existing industry accepted SIP extension, such as Session Initiation Protocol for Instant Messaging and Presence Leveraging Extensions (SIMPLE). As described, for example, on WIKIPEDIA™ at http://en.wikipedia.org/wiki/SIMPLE, SIMPLE is an instant messaging (IM) and presence protocol suite based on SIP. Unlike most IM and presence protocols used by software deployed today, SIMPLE is an open standard.

SIMPLE applies SIP to the problems such as registering for presence information and receiving notifications when such events occur, for example when a user logs in or comes back from lunch; sending short messages, analogous to SMS or two-way paging; and managing a session of real-time messages between two or more participants. Implementations of the SIMPLE based protocols can be found in SIP based devices, such as Softphones and Hardphones.

The SIMPLE presence specifications can be broken up into a number of parts. The core protocol machinery provides the actual SIP extensions for subscriptions, notifications, and publications. RFC 3265 defines the SUBSCRIBE and NOTIFY methods. SUBSCRIBE allows to subscribe to an event on a server, the server responds with NOTIFY whenever the event come up. RFC 3856 defines how to make use of SUBSCRIBE/NOTIFY for presence. Two models are defined: an end-to-end model in which each User Agent handles presence subscriptions itself; and a centralized model. The latter introduces the concept of a presence server; all subscriptions are handled by this server. The message PUBLISH (RFC 3903) allows User Agents to inform the presence server about their subscription states.

Presence information is coded in XML documents that are carried in the bodies of the respective SIP messages. RFC 3863 and RFC 4479 describe this procedure, RFC 4480 (RPID), RFC 4481, RFC 4482 (CPID) and various drafts describe contents and formats of the presence documents.

Privacy, policy, and provisioning. If the centralized model is used, the User Agents need a way to define who may subscribe to which amount of their presence information. RFC 4745 and RFC 5025 define a framework for authorization policies controlling access to application-specific data. The XCAP Protocol (RFC 4825), carried by HTTP, allows User Agents to communicate their presence rules to a XCAP server, which rules the information exposed by the presence server. RFC 3857 and RFC 3858 define a subscription event “watcher info”. User Agents may subscribe to this event to be informed who is subscribing to their presence information.

SIP defines two modes of instant messaging. The Page Mode makes use of the SIP method MESSAGE, as defined in RFC 3428. This mode establishes no sessions. The Session Mode. The Message Session Relay Protocol (RFC 4975, RFC 4976) is a text-based protocol for exchanging arbitrarily-sized content between users, at any time. An MSRP session is set up by exchanging certain information, such as an MSRP URI, within SIP and SOP signaling.

In addition, Central Office 102 provides storage of media information. For example, user personal media, such as voicemail, video mail, photos, etc., may be stored. Likewise, system media information, such as movies, music, etc., may be stored. Such storage is vendor specific. In general, common formats are used, but vendors may be allowed to use proprietary formats. In that case the actual vendor will need to use proprietary plugins to handle those proprietary formats. As far as storage goes, it could be file storage or database storage. Such storage may be capable of high performance date streaming.

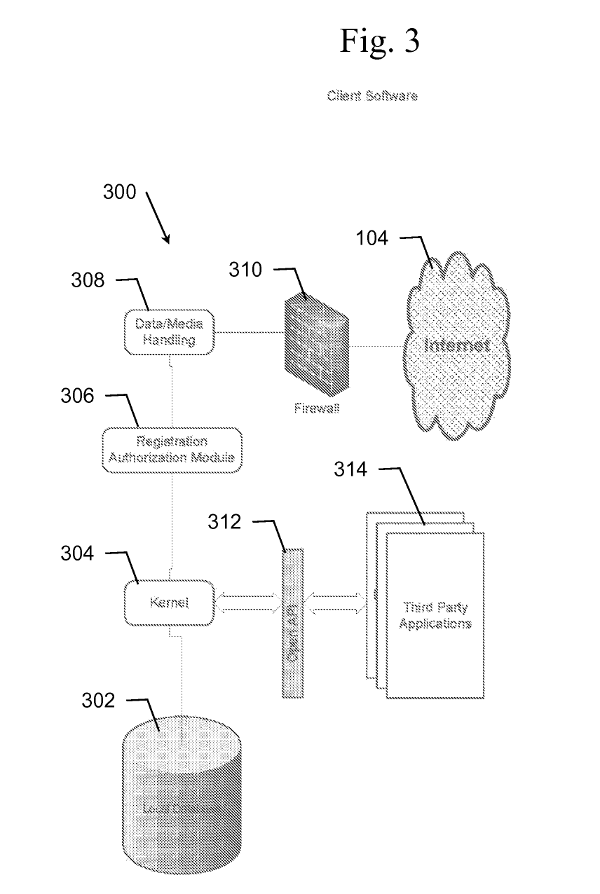

An exemplary block diagram of client kernel and application software 300 at subscriber residences 106 is shown in FIG. 3. Software 300 includes local database 302, client kernel 304, registration and authorization module 306, data/media handling 308, firewall 310, open API 312, and third party applications 314.

Registration and authorization module 306 handles validation requests from the client software 300. Client software 300 will have to register real time with the server and provide proper credentials. The may be based on SIP authentication, as, for example, is described above.

Client software 300 may allow third party application plug-ins 314 and may provide an Open API for such plug-ins.

Firewall 310 provides protection from security attacks. An example of a control function is described in U.S. Pat. No. 7,996,543 and in U.S. Patent Application Publication No. 2010/0218246, which mentioned above. Firewall 310 provides protection from different security attacks including SIP specific attacks. There are well-known potential vulnerabilities in the SIP protocol that can be exploited in the case of an incorrectly configured network. This may occur, for example, if a device allows calls from any IP address. It may occur, for example, when device (our end user client) is outside of firewall. However, when a device is behind the firewall, it is, in general, not accessible to the service provider unless the firewall is specially configured by end user, which is unlikely to occur with users in the general population. To resolve this as well as many similar issues, the device is placed behind firewall and Firewall 310 is included in the SDK.

Client software 300 may also provide location and presence functions such as providing information on user current Internet status and location. These functions may be based on the SIMPLE technology, as described above in relation to Central Office 102.

Client software 300 may also provide storage of media information such as user personal media, such as voicemail, video mail, photos, etc., and system media information, such as movies, music, etc.

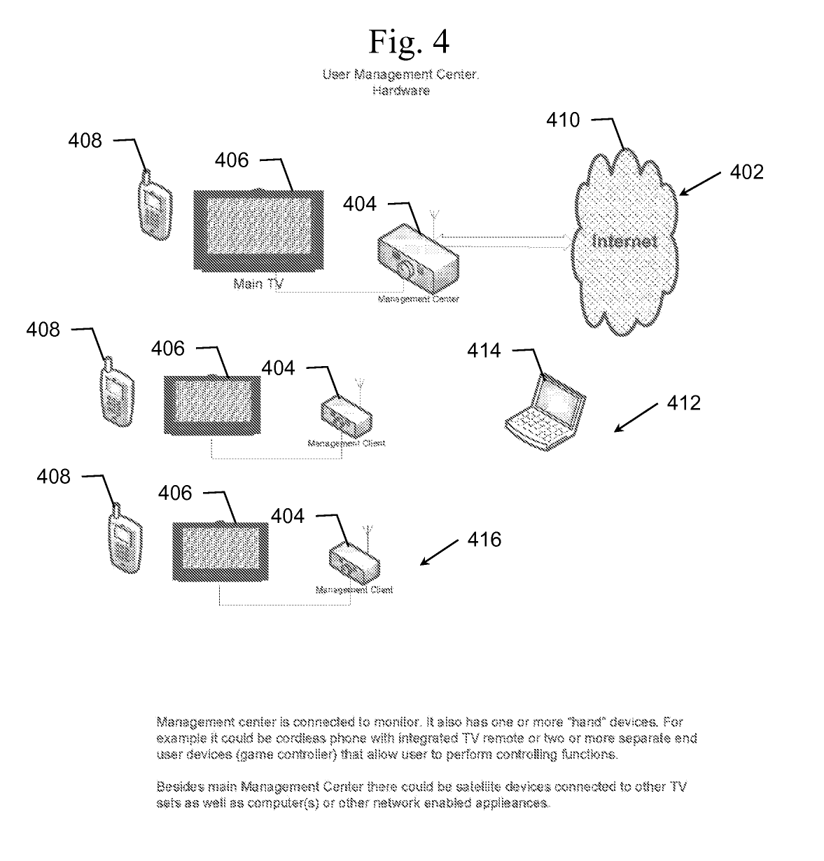

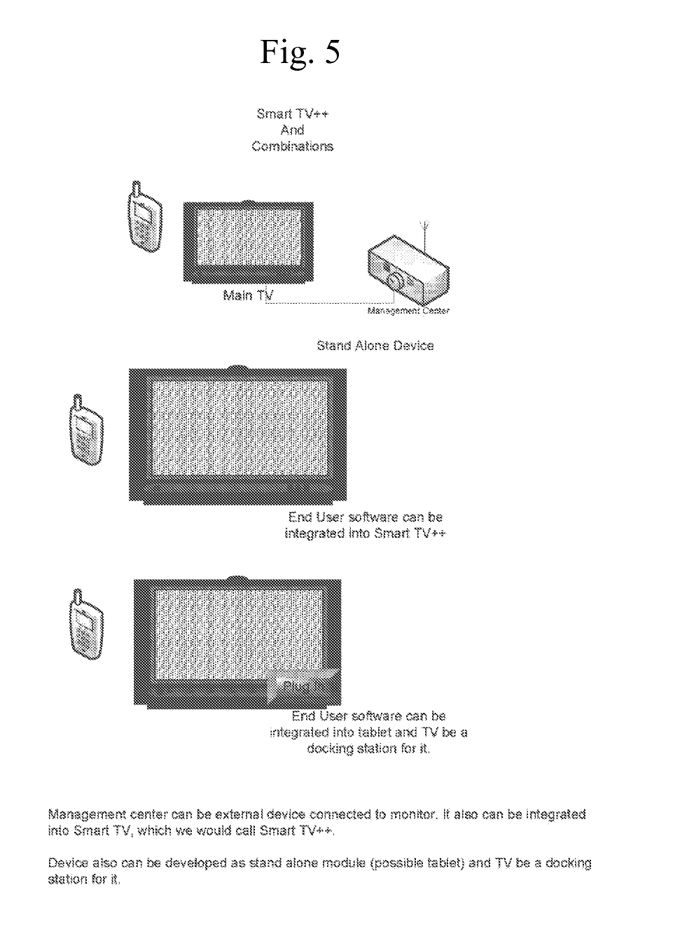

An example of client hardware configured to provide User Management Center functionality is shown in FIG. 4. Several configurations are shown. For example, configuration 402 includes client hardware such as Management Center device 404, display 406, wireless device 408, and internet connection 410. Configuration 412 includes client hardware such as Management Center device 404, display 406, wireless device 408, and personal computer 414. Configuration 416 includes client hardware such as Management Center device 404, display 406, and wireless device 408. Additional possible configurations are shown in FIG. 5.

Management Center device 404 may provide integration of functionalities such as an Internet appliance that allows watching TV over Internet 410 on regular TV, such as in configuration 402. Another function of Management Center device 404 may be playing games, including third party developed games, such as in configuration 402, 412, and 416. Another function of Management Center device 404 may be making phone calls, such as in configuration 402. However, the open API provides the capability to add additional applications. In addition, Management Center device 404 may be connected to Central Office 102, which would provide the capability to create different centralized features, such as Billing, client presence and location, promotion, etc.

Open API 312, shown in FIG. 3, may be based on shared libraries or have the ability to execute different application by issuing system or similar commands. The customers will be provided with ability to link their libraries. API allows to build third party applications in different languages, such as C#, C++, Java, etc. It may combine library, network (including XML) and RPC (remote procedure call) technologies. Management Center device 404 may be based on existing general-purpose personal computers (PC), existing gaming systems, or proprietary hardware, as long as adequate computing power is provided.

Management Center device 404 may have regular internet connection. Most likely it will be over Wi-Fi as well as cable. In some cases, Management Center device 404 may incorporate a cable/DSL modem in it. Management Center device 404 may have HDMI/Component output for TV as well as audio channels for high quality audio. Likewise, Management Center device 404 may have additional USB ports to connect webcams and it may have microphone/speaker ports. A TV set may be connected to Management Center device 404 over one wire, rather than the conventional connections involving one for cable, one for DVD, one for computer or internet appliance, one for VCR, etc.

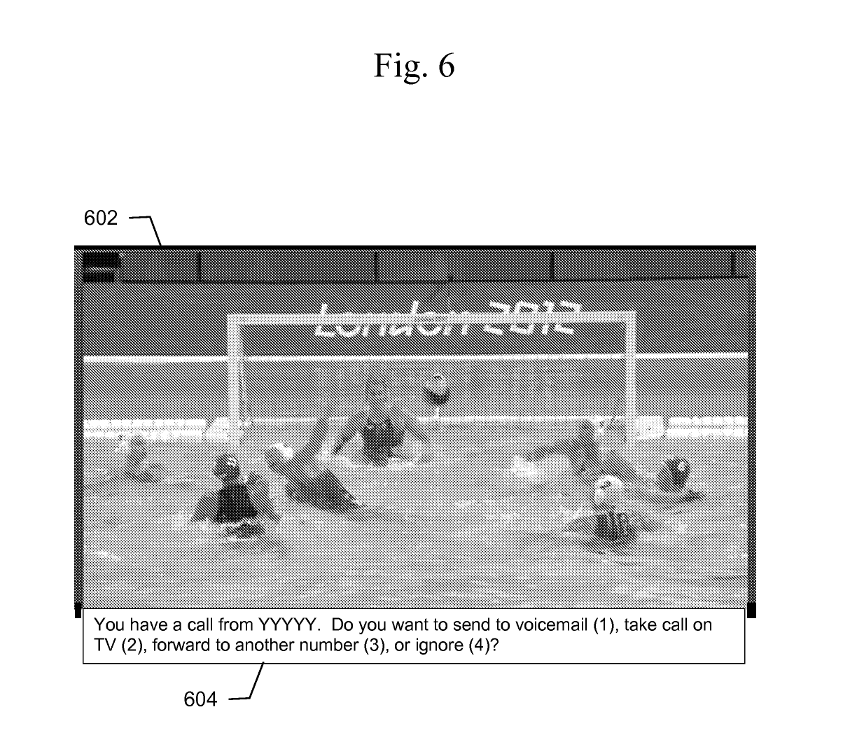

For example, referring to FIG. 6, assume one is watching TV 602. An incoming phone call arrives. Management Center device 404 may receive caller information (caller ID) from the call and display on screen a message 604, such as to video signal the message: “You have a call from YYYYY. Do you want to send to voicemail (1), take call on TV (2), forward to another number (3), or ignore (4)?” Picking up a handset would be another possibility to answer the call. If the call is accepted, Management Center device 404 could offer a function such as: “Press one to pause the video, two to mute, etc.”, using, for example, DVR functionality or pausing streaming video, etc.

The message information will be incorporated into the video stream coming to the TV by Management Center device 404. It could be presented as a text line, as shown in the example in FIG. 6. It also would allow using remote control to manage the call. The easiest solution would be to create another non-transparent window that will be placed at the bottom of main window with text message, as shown in the example in FIG. 6.

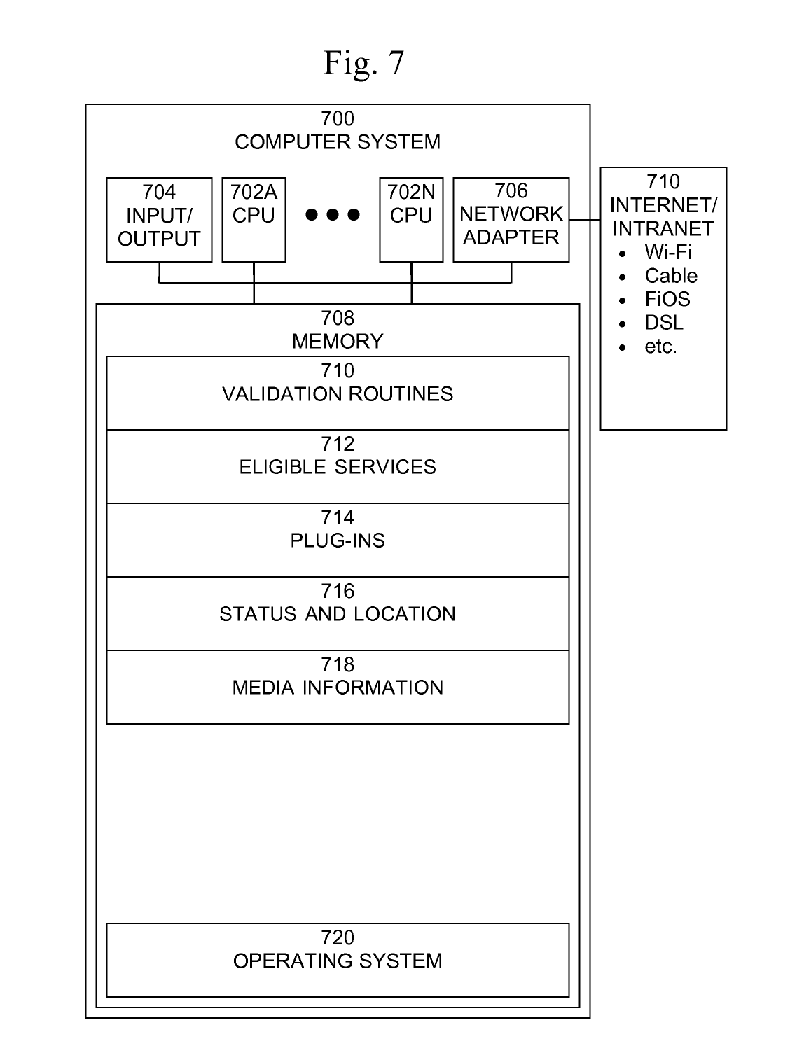

An exemplary block diagram of a Management Center device 700. Management Center device 700 is typically a programmed general-purpose Management Center device, such as a personal computer, workstation, server system, and minicomputer or mainframe computer. Management Center device 700 includes one or more processors (CPUs) 702A-702N, input/output circuitry 704, network adapter 706, and memory 708. CPUs 702A-702N execute program instructions in order to carry out the functions of the present invention. Typically, CPUs 702A-702N are one or more microprocessors, such as an INTEL PENTIUM® processor. FIG. 7 illustrates an embodiment in which Management Center device 700 is implemented as a single multi-processor computer system, in which multiple processors 702A-702N share system resources, such as memory 708, input/output circuitry 704, and network adapter 706. However, the present invention also contemplates embodiments in which Management Center device 700 is implemented as a plurality of networked computer systems, which may be single-processor computer systems, multi-processor computer systems, or a mix thereof.

Input/output circuitry 704 provides the capability to input data to, or output data from, Management Center device 700. For example, input/output circuitry may include input devices, such as keyboards, mice, touchpads, trackballs, scanners, etc., output devices, such as video adapters, monitors, printers, etc., and input/output devices, such as, modems, etc. Network adapter 706 interfaces device 700 with a network 710. Network 710 may be any public or proprietary LAN or WAN, including, but not limited to the Internet, one or more Wi-Fi networks, Cable data and video networks, FiOS, DSL, etc.

Memory 708 stores program instructions that are executed by, and data that are used and processed by, CPU 702 to perform the functions of Management Center device 700. Memory 708 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 708 varies depending upon the function that Management Center device 700 is programmed to perform. In the example shown in FIG. 7, memory contents that would be included in a personal computer are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 7, memory 708 includes validation routines 710, eligible services 712, plug-ins 714, status and location 716, media information 718, and operating system 720. Validation routines 710 perform client validation as described above. Eligible services 712 includes data relating to services the user is eligible and/or ineligible to receive. Plug-ins 714 may include third party application plug-ins and may include an Open API for such plug-ins. Status and location 716 include location and presence functions such as providing information on user current Internet status and location. Media information 718 provides storage of media information such as user personal media, such as voicemail, video mail, photos, etc., and system media information, such as movies, music, etc. Operating system 732 provides overall system functionality.

As shown in FIG. 7, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while aspects of the present invention have been described in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for providing unified services comprising:
a server system utilizing a universal open protocol that provides the capability for different service providers to offer services over unified cable/TV/Internet network independent technologically from particular network providers; and
a plurality of client systems, each client system utilizing the protocol to provide integrated services to a user.

2. The system of claim 1 wherein:
the client system is connectable to, and compatible with, existing televisions and monitors.

3. The system of claim 1 wherein:
the client system is included in a television.

4. The system of claim 1 wherein:
the protocol has a session negotiation and identification part and a session description part.

5. The system of claim 4 wherein:
the session negotiation and identification part is Session Initiation Protocol and the session description part is Session Description Protocol.

6. The system of claim 4 wherein:
the protocol is open and allows custom or public extensions.

7. The system of claim 6 wherein:
the protocol includes Session Initiation Protocol for Instant Messaging and Presence Leveraging Extensions.

8. The system of claim 1 wherein:
the client system provides a firewall that does not need configuration by the user.

9. The system of claim 1 wherein:
the server system provides authorization and collection of payment from users by an operator of the server system, an independent provider, or both.
